(19) United States
(12) Patent Application Publication
(10) Pub. No.: US 2007/0116427 A1
(43) Pub. Date: May 24, 2007

(54) BROADCASTING RECORDING

(75) Inventor: Ryou Sung Youn, Gunpo-si (KR)

Correspondence Address: FISH & RICHARDSON P.C., P.O. BOX 1022, MINNEAPOLIS, MN, 55440-1022, US

(73) Assignee: LG Electronics Inc., Youngdunpo-gu (KR)

(21) Appl. No.: 11/532,780

(22) Filed: Sep. 18, 2006

(30) Foreign Application Priority Data
Nov. 21, 2005 (KR) 10-2005-0111453

(51) Int. Cl. H04N 5/91

(52) U.S. Cl. 386/83

(57) ABSTRACT

Digitally broadcast content is viewed through a portable terminal. One or more devices within a network configured to receive and record digitally broadcast content are queried, such as through the portable terminal. The digitally broadcast content is recorded using one or more of the queried devices within the network and in response to instructions or information transmitted through the portable terminal.

### BACKGROUND

This description relates to a portable terminal capable of recording a broadcast program.

Mobile multimedia broadcasting includes broadcasting or transmitting television broadcasting, radio broadcasting, and/or data broadcasting using multiple channels with the primary purpose of receiving broadcasted material in a portable terminal. The mobile multimedia broadcasting is realized as digital audio broadcasting (DAB) in Europe, digital audio radio (DAR) in the United States, digital multimedia broadcasting (DMB) in Korea, digital radio broadcasting (DRB) in Canada, ground wave digital audio broadcasting in Japan, and digital sound broadcasting (digital satellite radio) (DSR) in International Telecommunication Union (ITU)-R. These mobile multimedia broadcasting systems also provide digital voice service.

Based on digital voice service, technology development has made it possible to convey more data on limited electric waves. Accordingly, it is possible to transmit moving image data in the form of compact disk (CD)-level, digital versatile disk (DVD)-level, and as voice data.

DMB, for example, may include ground wave digital multimedia broadcasting and/or satellite digital multimedia broadcasting. DMB include broadcasting services allowing a user to view various multimedia broadcasting while moving using a personal digital assistant (PDA) or a receiver for an automobile.

Digital broadcasting is rapidly proceeding through the existing media, such as ground waves, satellites, cable TV broadcasting. Digital multimedia broadcasting is changing the broadcasting industry environment and is emerging in response to a trend toward the integration of digital broadcasting with communication among various other media. One of the significant characteristics of the DMB service is the ability to view digital television broadcasting while moving.

The DMB service may be implemented by integrating DMB with a portable terminal supporting a communication function. The portable terminal may include a cellular phone, a PDA, a portable computer, and/or an MPEG layer 3 (MP3) player.

When viewing the broadcasting using the portable terminal, a user can view the broadcasting for a predetermined period of time that may be limited by the available power from a battery mounted in the portable terminal. The usage time provided by the battery may be reduced depending on the size of the display screen or the resolution of a screen of the portable terminal used to broadcast content.

When viewing the broadcast content using the portable terminal, a user may not be able to view the entirety of the broadcast content and/or the quality of the user's experience may be limited by the battery.

### SUMMARY

A broadcasting recorder capable of delivering, at a portable terminal, broadcast recording information to an Internal protocol (IP)-based device may allow the IP-based device to receive and record the broadcasting. The portable terminal also may be able to check storage capacity information of other IP-based devices as well as to explore other IP-based devices, and to continuously record broadcast using another IP-based device when a memory is exhausted while recording using one device.

In one general aspect, recording broadcast content includes viewing digitally broadcast content through a portable terminal. One or more devices configured to receive and record digitally broadcast content within a network are queried, and the digitally broadcast content is recorded using one or more of the queried devices within the network.

Implementations may include one or more of the following features. For example, querying one or more devices may include determining if the portable terminal is capable of receiving or recording broadcast content.

Querying one or more devices may include determining if the portable terminal includes adequate memory or sufficient power to receive or record broadcast content.

A user may be informed of a recording request if viewing of the digitally broadcast content is limited by available memory or battery power.

A determination of available memory of the portable terminal may be made based on a threshold value. Similarly, a determination of available battery power of the portable terminal may be made based on a threshold value, or if the portable terminal is within a vicinity of a broadcasting blind zone. Querying the one or more devices may be in response to determining if available memory or battery power is less than the threshold value, or if the portable terminal is within the vicinity of a broadcasting blind zone.

A program viewed by the portable terminal may be recorded with one or more of the queried devices. The portable terminal and the one or more queried devices may be accessed based on respective IP addresses.

The one or more devices may be queried by accessing a home server through the portable terminal, and obtaining information relating to the one or more devices through the accessed home server. The information relating to the one or more devices may include one or more of a device execution code, IP address information, product information, or storage capacity information.

The digitally broadcast content may be recorded by accessing the one or more queried devices through the terminal, and transmitting broadcasting record information to the one or more accessed devices.

In another general aspect, recording broadcast content includes querying one or more IP-based devices through a portable terminal and a network. An IP-based device queried through the portable terminal is selected based on available data storage capacity. Recording information relating to digitally broadcast content is transmitted to the selected IP-based device.

Implementations may include one or more of the following features. For example, the digitally broadcast content may be recorded with the selected IP-based device, and the content may be viewed through the portable terminal.

The recording information relating to digitally broadcast content may include information relating to a broadcast channel currently viewed and information that instructs termination of a recording operation of broadcast content.

In another general aspect, recording content with a broadcasting device includes requesting a recording request for broadcast content through a portable terminal. Device information relating to recording broadcast content is requested from the portable terminal in response to the recording request. Broadcast recording information is received from the portable terminal and the broadcast content is recorded using the broadcasting recording information with a device other than the portable terminal.

Implementations may include one or more of the following features. For example, one or more IP-based devices other than the portable terminal may be queried by the portable terminal if a data storage capacity, battery power or broadcast reception capability of the portable terminal is less than an optimum value. Information relating to the IP-based devices may be accessed based on the respective IP addresses.

The broadcasting recording information may be transmitted to a selected IP-based device having sufficient recording capability. The broadcast content may be recorded with the selected IP-based device.

In another general aspect, a portable terminal includes a receiver part configured to receive and process digitally broadcast content. The portable terminal includes a radio part configured to access a wireless network on the basis of an IP (Internet protocol) address, and a controller configured to control the receiver part and the radio part. The controller is configured to detect one or more limitations on viewing broadcast content through the portable terminal, to inform a user of a recording request, and to query a network or memory within the portable terminal to determine if an alternative IP-based device can record broadcast content received through the receiver part, but which the portable terminal is not capable of recording.

Implementations may include one or more of the following features. For example, the controller may be configured to determine if the portable terminal is capable of receiving or recording broadcast content.

The controller may be configured to determine if the portable terminal includes adequate memory or sufficient power to receive or record broadcast content, and to inform a user of the portable terminal of a recording request if viewing of the digitally broadcast content is limited by available memory or battery power.

Other features will be apparent from the following description, including the drawings, and the claims.

### BRIEF DESCRIPTION OF THE DRAWINGS

FIG. 1 is a schematic view of a digital broadcasting and recording network.

FIG. 2 is a block diagram of a portable terminal.

FIG. 3 is a block diagram of a home network.

FIG. 4 is a flowchart of a process for recording and receiving broadcast content.

FIG. 5 is a flowchart of an exemplary process for recording broadcast content when resources for a portable terminal are limited.

FIG. 6 is a flowchart of an exemplary process for recording broadcast content when resources for a portable terminal are limited.

FIG. 7 is a flowchart of a process of responding to a recording request if a portable terminal is near a broadcasting blind zone.

FIG. 8 is a flowchart of an exemplary process for recording broadcast content.

### DETAILED DESCRIPTION

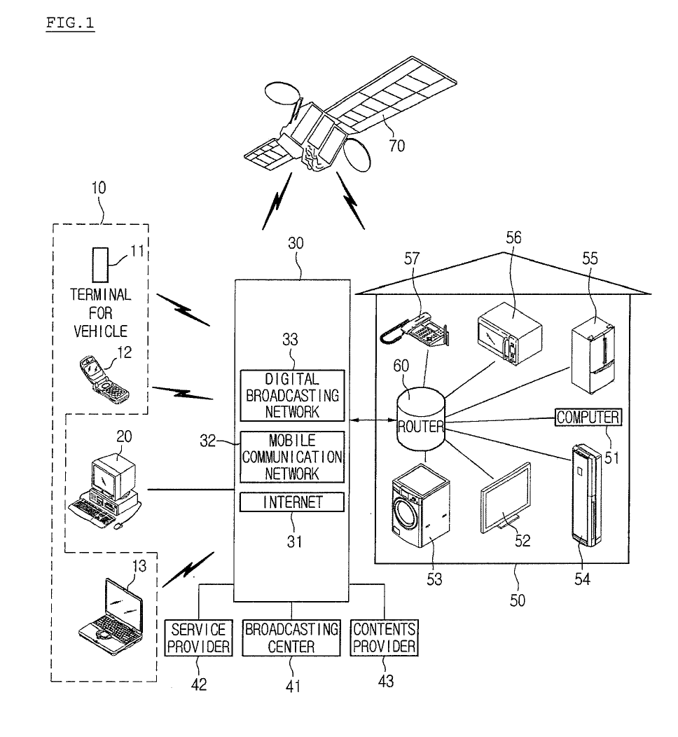

Referring to FIG. 1, a broadcasting system includes a portable terminal 10 for receiving broadcast content while moving, a home server 20, and a wired/wireless network 30 for providing a variety of services to wired/wireless terminals. A broadcasting center 41 for broadcasting content, a service provider 42, and a content provider 43 are included in the broadcasting system. IP (Internet Protocol)-based devices 51 to 57 are connected on a network 50 with a router 60. A satellite 70 for satellite broadcasting or for global positioning system (GPS) transmission is also provided in the broadcasting system.

The portable terminal 10 includes a terminal 11 for a vehicle, a cellular phone 12, a portable computer 13, an MP 3 player, a portable multimedia player (PMP), and a personal digital assistant (PDA). Each portable terminal may receive satellite digital mulitimedia broadcasting, ground wave digital multimedia broadcasting (DMB), such as DMB and DTV, and/or GPS signals. One or more of the portable terminals may also be capable of recording broadcast content.

The portable terminal 10 may provide traffic information services based on map information and GPS signals received through the satellite 70. In addition, or in the alternative, the portable terminal 10 may include a cellular phone function, wireless access to the Internet, and/or a broadcasting viewing function through a wired/wireless network 30.

The portable terminal 10, while moving, can receive the digital broadcasting through a digital broadcasting network 33 or through the satellite 70. The portable terminal 10 can provide voice communication and data communication through a mobile communication network 32.

Satellite DMB includes service in which a user receives a variety of multimedia information through a PDA or a terminal for a vehicle using a broadcasting satellite or communication satellite, regardless of whether the user is moving or stationary. For example, an earth station transmits a variety of multimedia information, such as high quality multi-channel audio broadcasting, traffic information, car navigation information, and weather information received from a program provider to a satellite, and the frequency of the multimedia information is converted and transmitted to the ground. The frequency of the multimedia information may be converted into a frequency of an L band (1 GHz-2 GHz), an S band (2 GHz-4 GHz), or a Ku band (12 GHz-14 GHz) through a satellite relay, and the multimedia information is then transmitted to ground-based receivers capable of processing the converted multimedia information.

Satellite DMB provides a discriminative mobile service different from a ground wave digital television or stationary reception satellite radio broadcasting. In addition, the satellite DMB service provides a multi-channeled and high quality service compared with existing media services.

The portable terminal can transmit and receive data through multiple antennas within a mobile communication environment using a multiple-input multiple-output (MIMO) technology. The portable terminal can perform wide-band transmission by dividing and assigning a frequency and a time component using an orthogonal frequency division multiplexing (OFDM) technology, and can perform selective transmission and reception to reduce an influence of interference signals using a smart antenna technology.

The portable terminal 10 can operate on the basis of an IP-based network on the wired/wireless network 30, and therefore can mutually communicate with other IP-based devices on the basis of the IP. Since an IP multimedia subsystem (IMS) assigns IP addresses to all of the wired/wireless devices existing on the network, the wired/wireless devices can communicate with each other on the basis of their IP addresses.

Also, the wired and wireless network 30 includes a wired network or a ground wave digital broadcasting network 33 for transmitting broadcasting signals, a mobile communication network 32 for a mobile telephone, and stationary and portable Internet 31 access and service.

The service provider 42, the broadcasting center 41, and the content provider 43 are provided to enable the services associated with the wired and wireless network 30. The service provider 42 manages service subscribers of the mobile communication network 32, and the broadcasting center 41 services satellite digital multimedia broadcasting, ground wave digital multimedia broadcasting, and/or satellite and ground wave digital television broadcasting. The content provider 43 provides a variety of content through the Internet 31 or the broadcasting center 41. The satellite 70 includes a satellite for digital broadcasting or a satellite for digital multimedia broadcasting, a GPS satellite, and/or a satellite for communication.

The home network devices 51 to 57 are connected through the home network 50. The home network 50 further includes the router 60 so as to discriminate and manage the IP-enabled devices 51 to 57. A personal computer (PC) 51 may include a server so as to manage the IP numbers of the devices provided to the home network 50. The IP numbers of the devices may also be managed using an external home server 20.

The exemplary home network 50 includes IP-enabled devices such as a PC 51, a digital television (TV) 52, a washing machine 53, an air conditioner 54, a refrigerator 55, an electric oven range 56, and an IP-enabled telephone 57. The devices 51-57 are connected to the router 60 and have their own unique IP addresses. The devices of the home network 50 may also receive and record broadcasting signals. For example, the PC 51 or the digital TV 52 includes a broadcasting receiver and a large-capacity memory device, and each may receive or record a broadcasting program using the respective large-capacity memory device.

The digital TV 52 may include a set-top box and a digital video storage device within or exterior to the TV 52, and/or may receive and record the digital broadcasting using the set-top box and the digital video storage device.

Broadcast content can be recorded using other portable terminals or other stationary reception devices while a user views broadcast content using a device for receiving the broadcasting on the home network. Since the portable terminal or the stationary reception device on the network can be searched on the basis of their IP addresses, broadcast channel information may be delivered to other IP-based devices, so that a broadcast program for the same channel can be recorded in real-time.

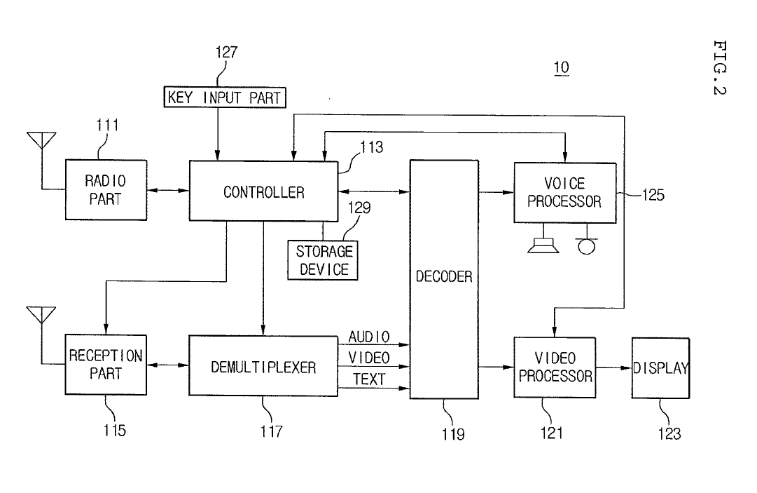

Referring to FIG. 2, a radio part 111 converts radio signals received from an antenna ANT into predetermined signals and delivers the same to a controller 113 or a voice processor 125 under control of the controller 113. The radio part 111 also converts coded signals received from the voice processor 125 into signals of a band used in transmitting radio signals and outputs the same to the antenna ANT. Signals outputted from the radio part 111 to the controller 113 may be pilot signals and/or paging signals from a base station, data received during data communication, and/or messages received from the base station of the mobile terminal for power control.

The controller 113 delivers call set data, power control data, or data to be transmitted during data transmission to the radio part 111, thereby transmitting those data to the base station. Therefore, signals output from the radio part 111 to the voice processor 125 may be coded audio signals received after a call is set.

The controller 113 controls the overall operation of the portable terminal 10. For example, the controller 113 checks if reception failure occurs within a system during reception of digital multimedia signals, and/or if there is a recording request received from a user. The controller 113 controls the radio part 111 and a recording request to other devices depending on the occurrence of the reception failure.

The reception of the broadcasting may be limited in the portable terminal 10. For example, the reception of the broadcasting may be limited in the case where the digital multimedia broadcasting cannot be viewed due to battery problems or insufficient power. The controller 113 may determine if the battery is providing adequate power, such as within a predetermined period of time (e.g., every three minutes), while the broadcasted content is viewed. If a digital multimedia broadcasting program cannot be recorded in a storage device due to memory shortage, the reception of content may also be limited. In addition, if the portable terminal has entered a broadcasting blind zone, the digital multimedia broadcasting signals may not be reliably or fully received by the portable terminal.

A user viewing digital multimedia broadcasting through one device, or not viewing content at all, may request another stationary reception device or devices to record digital multimedia broadcasting content through a digital multimedia broadcasting channel or channels.

A reception part 115 receives digital multimedia broadcasting signals containing multiplexed video signals, audio signals, and additional signals. The video signals, the audio signals, and the additional signals are compression-coded using separate packets, respectively, and then multiplexed and transmitted. The video signals and the audio signals may be compression-coded using a general compression method such as H.264 (MPEG4 p.10) or MPEG-4 AAC. The additional signals include text signals, e.g., caption data, associated with video signals and audio signals.

The digital multimedia signals may be digital multimedia broadcasting signals transmitted from a satellite, ground waves, and/or a gap filter. The digital multimedia signals may also be digital multimedia data stream broadcasting signals, a video on demand (VOD) signal, a music on demand (MOD) signal, or an audio on demand (AOD) signal. In addition, other signals other than DMB signals may be broadcast to the portable terminals.

The reception part 115 amplifies a low noise component of the received digital multimedia signals and then converts the amplified signal into intermediate frequency (IF) signals. The IF signals are spectrum-despread by a spreading code that corresponds to a reception channel designated through the key input part 127 by a user. The despread channel signals are demodulated by a demodulator (not shown). The demodulated channel signals are inputted to the demultiplexer 117. The demultiplexer 117 separates the demodulated channel signals from the reception part 115 into audio signals, video signals, and text signals. The separated audio signals, video signals, and text signals are input to the decoder 119.

The decoder 119 includes an audio decoding unit, a video decoding unit, and an additional signal decoding unit. The audio decoding unit (not shown) decodes the coded audio signals and outputs the decoded audio signals to the voice processor 125. The video decoding unit decodes the coded video signals and outputs the decoded video signals to the display 123 via the video processor 121. The additional signal decoding unit decodes additional signals containing text signals and outputs the decoded text signals together with the video signals to the display 123 via the video processor 121.

The text signals may be controlled so that text may not be displayed on the display 123 under control of the controller 113 and based on a selection of a user. The decoder 119 also decodes multimedia signals, such as moving images and music, stored in advance in the memory 126.

The voice processor 125 includes a voice codec for converting coded audio signals from the radio part 111 into electrical voice signals to output the same through the speaker or for coding electrical voice signals received from a microphone (MIC) to deliver the same to the radio part 111. The voice processor 125 may include a stereo codec for converting decoded audio signals from the audio decoding unit of the decoder 119 into stereo audio signals.

The video processor 121 converts decoded video signals from the video decoding unit of the decoder 119 into screen data to be displayed on the display 123, and provides the screen data to the display 123. The display 123 displays an image on a screen using video signals output from the video processor 121, and displays user data output from the controller 113.

The key input part 127 has a key matrix structure and includes numerical keys for dialing and function keys for performing a variety of functions. The key input part 127 generates a key signal that corresponds to a key input by a user and provides the key signal to the controller 113. Also, the key input part 127 includes a separate function key or a multi-function key for receiving digital multimedia data and a voice communication request. The key input part 127 may also be realized in the form of a touch pad or a visual keyboard.

A user carrying the portable terminal 10 can select a broadcast channel using the reception part 115 and view broadcasts from the selected channel using the speaker and the display 123 through the demultiplexer 117, the decoder 119, the video processor 121, and the voice processor 125.

Broadcasting may be limited due to limited battery power or a lack of available memory experienced during a recording operation. Alternatively, or in addition, broadcasting may be limited due to the existence of a broadcasting blind zone caused by the local topography or surrounding structure while a user attempts to view digital multimedia broadcasting content transmitted through satellite or ground waves. A user may be requested to select whether to record the digital multimedia broadcast content being viewed or received. If a user selects to record the digital multimedia broadcast content, a recording request is transmitted to the home server 20 through the radio part 111.

The portable terminal 10 (such as the terminal 10 within the system of FIG. 1) may access the home server 20 wirelessly to request and receive device information from the home server 20. The home server 20 delivers device information from the home network 50, e.g., such as from a database (DB), to the portable terminal 10. The device information includes code information for a device, product information, an IP address, and/or data storage capacity information. In addition, the device information may include information relating to receiving and recording broadcast content.

The home server 20 provides the device information of the home network 50 in the form of a table, so that the portable terminal stores the received device information and provides the information to a user.

For example, exemplary device information table is provided in Table I:

| | | | Storage capacity |
|---|---|---|---|
| Code | Product | IP Address | (basic/residual) |
| 1C xx | PC | 156.147.135.352.345 | 120 G/50 G |
| 1D xx | TV | 156.147.135.352.346 | 60 G/30 G |
| 1E xx | Refrigerator | 156.147.135.352.347 | 30 G/20 G |
| . . . | . . . | . . . | . . . |

The code information, which is an identifier for executing the respective products, may be the same code or different codes. The product information represents the devices connected to the home network (household and office), the IP addresses represent addresses of the respective devices existing on the home network, and the storage capacity information represents the basic capacities and the residual capacities of the respective devices. The home server or the PC periodically updates the storage capacities of the respective devices so as to provide current storage capacities.

A user of the portable terminal 20 checks the storage capacity of the respective devices using the provided device information and then selects a device. For example, the device may be selected by the user based on residual capacity, and may be accessed using an IP address of the device. The selected device may be selected based on which of the devices that can receive and record broadcast content has the largest residual capacity. In addition, or in the alternative, the selected device may be automatically accessed.

If a user of the portable terminal 20 accesses the device, the controller 113 transmits the broadcast recording information for the device using the IP address of the device. The broadcast recording information includes broadcast channel information. Also, the broadcast recording information may further include a broadcasting program code, a recording start time, and a recording end time.

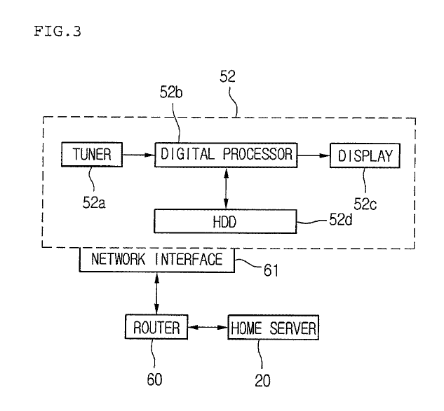

Referring to FIG. 3, an exemplary digital TV 52 includes a tuner 52a for receiving analog or digital broadcasting, a digital processor 52b for processing broadcast signals received through the tuner 52a into signals that can be displayed on a screen, and a storage device (e.g., a hard disk drive (HDD)) that provides large-capacity data storage for storing the signals processed by the digital processor 52b. A display 52c is provided for displaying the signals processed by the digital processor 52b.

The digital TV 52 is connected to a home network through a network interface 61. A home server 20 or a PC 51 stores and searches for the IP address of the digital TV and provides and/or manages a program list using the network interface 61 and a router 60. The home network may provide the network interface using the wired/wireless local area network (LAN), or using a modem or power line communication.

If the digital TV receives the broadcast recording information, a controller (not shown) controls the tuner 52a to select a broadcast channel. The digital processor 52b decodes and demultiplexes signals of the selected broadcast channel. The decoded and demultiplexed signals are stored in the storage device 52d. The controller may supply power to the respective part of a system when receiving code information from the broadcast recording information.

The digital TV selects a channel using broadcast channel information and records a broadcast program received through the selected broadcast channel. When the broadcast program that is being recorded is ended or a recording time period has ended, the recording is automatically stopped. If memory capacity within the device is limited, the recording, such as of broadcast TV content, may alternatively be performed using the PC (or any other device for recording content). It is possible to continuously record a currently broadcast program by transmitting the broadcast recording information to other broadcast recording devices or by sharing the broadcast recording information through the home server. The broadcast program may include a program received through a satellite, sky waves, and a cable.

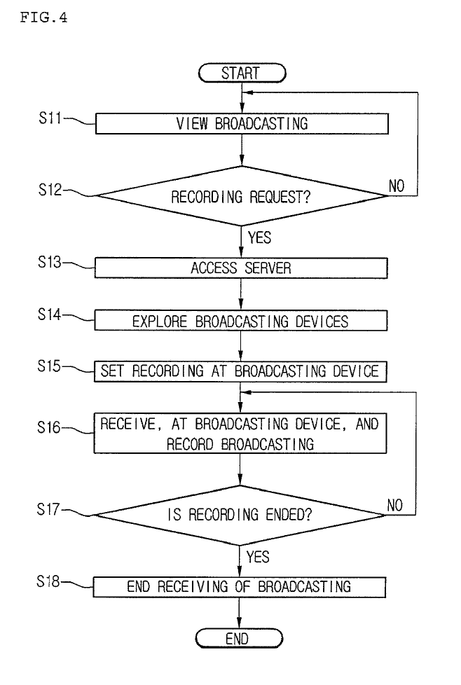

Referring to FIG. 4, a portable terminal receives broadcasting signals through ground waves or a satellite broadcasting network, so that a user can view a selected broadcasting channel (S11). The system then determines if a user has made a recording request (S12). If the user has made a recording request, a home server is accessed (S13) and IP-based broadcast devices are searched (S14). For example, an IP-based portable terminal accesses an IP-based home server and searches or queries the IP-based broadcasting devices managed by the home server. The devices may be devices managed on a web or devices managed by a separate service provider.

The broadcasting devices are queried by the portable terminal and one of the broadcasting devices is accessed and then broadcast recording information is delivered to the one broadcasting device, so that recording setting is performed (S15). It is possible to record content by accessing the broadcasting device using the device's IP address and transmitting the broadcast recording information to the broadcasting device. The broadcasting device accessed using the IP address may be a device configured to receive and record broadcast content.

The broadcasting device then selects and receives a broadcast channel according to the broadcasting recording information, and records a program of the received broadcast channel (S16).

The broadcast recording information is used to determine if the recording is complete (S17). If the recording is complete, the receiving and recording operations of the broadcast content are ended (S18). The determination to interrupt recording or the receipt of content may be implemented through a program or through a predefined broadcasting period having a start time and an end time.

The portable terminal may access the home server and then directly access the broadcasting device linked to the home server. Alternatively, the portable terminal may download device information from the home server, check the device information, and access the device using an IP address to transmit the appropriate broadcasting recording information.

Instead of a user directly selecting the broadcasting device, a device having the largest available storage capacity may be automatically selected and accessed using the device information. The portable terminal transmits an execution code for each device together with the broadcasting recording information after the device is accessed and selected. The device may then automatically receive and record broadcast content, such as cable, sky wave, and/or satellite broadcasting.

If the portable terminal stores the device information in advance, the portable terminal may not need to access the home server, but may instead directly access the home network to record broadcasted content.

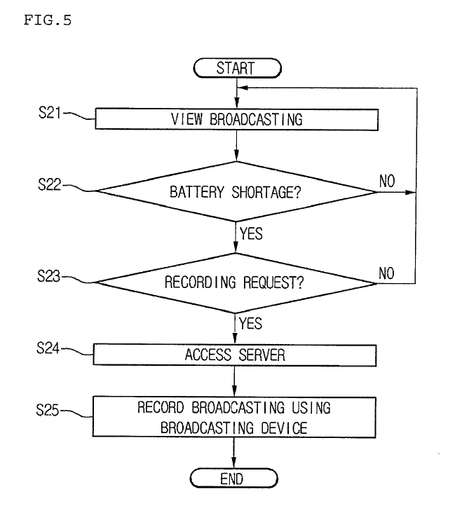

Referring to FIG. 5, the available battery power is checked (S22) while a portable terminal is used to view DMB content (S21). If the battery has a limited power supply that may be exhausted within a predetermined period of time (S22), a recording request for a broadcasting program currently viewed is provided to a user (S23). The recording request due to the battery shortage is performed when the battery is to be exhausted during a predetermined period of time (e.g., within ten minutes). The details of the recording request may be set in advance as an option by a user, or may be set as a system default.

If a user makes a recording request, the portable terminal accesses a home server (S24), obtains device information, and transmits recording information to a device so that a broadcasting program is recorded at a time point when the recording information is received (S25).

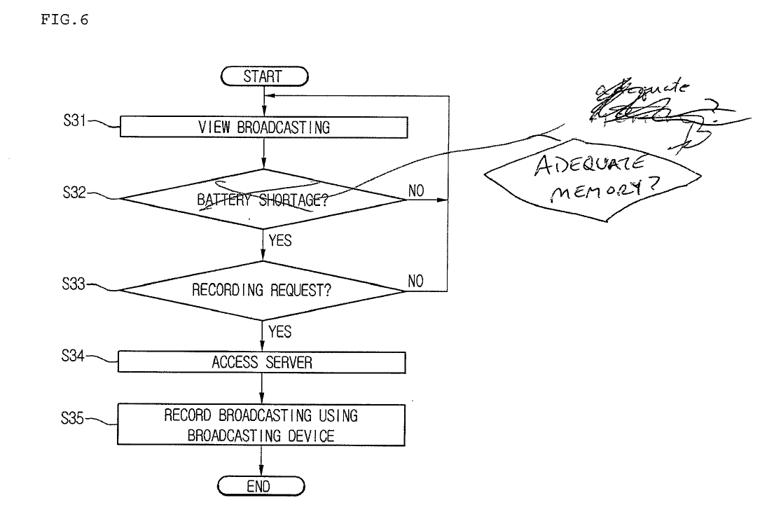

Referring to FIG. 6, when viewing DMB content through a portable terminal (S31), the available memory space is queried to determine if the portable terminal will soon be without available memory space (S32). If the memory will be exhausted, such as within a predetermined time period, a recording request is provided to a user (S33). If a user then approves the recording request, the portable terminal accesses a home server wirelessly (S34) and requests device information from the home server. When receiving the device information from the home server, the portable terminal extracts device information containing devices having sufficient recording capacities, and transmits broadcast recording information to the device having the sufficient recording capacity. The devices having sufficient recording capacity receive and record the DMB content (S35).

If a recording space is less than a predetermined amount during the recording operation, or when an assigned memory space is less than the anticipated or estimated DMB program to be recorded by the device, the user may be notified of the potential memory shortage.

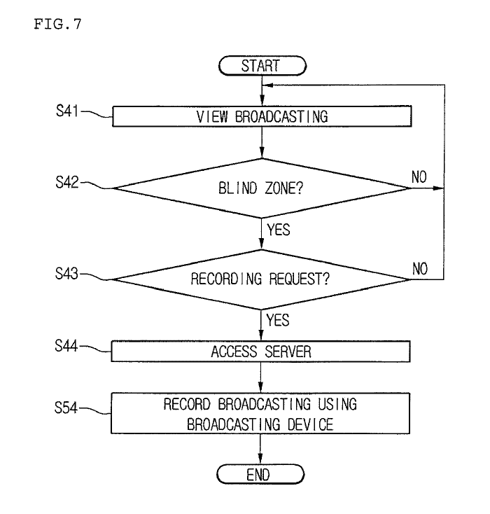

Referring to FIG. 7, a user carries a portable terminal and travels or moves while viewing a digital multimedia broadcast (S41). If a broadcasting blind zone exists relative to a travel route as determined through a traveling direction (S42), the user is informed of a recording request (S43). Specifically, the portable terminal prompts the user to decide if the DMB content should be recorded since the portable terminal may soon be encountering or entering a blind zone. The blind zone information may be information downloaded from a broadcasting station, or blind zone information stored in a memory of a device and/or set by a user.

If the recording request is made, the portable terminal accesses a home server (S44) to receive IP-based device information. After selecting one device for recording DMB content, the portable terminal accesses the selected device or transmits broadcasting recording information to the device. An access priority may also be assigned to each of the devices so that the devices are automatically accessed according to the access priority.

The selected device receives and records DMB content or programs through a broadcasting channel according to the broadcasting recording information (S45). For example, in the case where the device is a TV, the TV selects a broadcast channel contained in the broadcast recording information when received by the TV. The TV demultiplexes and decodes a broadcast program received through the selected broadcast channel, and then records the broadcast program.

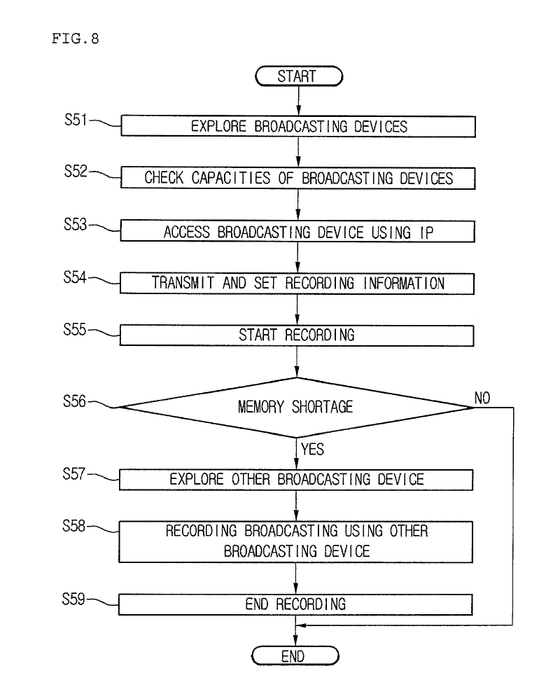

Referring to FIG. 8, a portable terminal explores broadcasting devices (S51) and determines the battery and/or memory capacities of the broadcasting devices (S52). At this point, the portable terminal accesses one of the broadcasting devices using an IP address thereof (S53), and transmits broadcast recording information to the device to initiate recording of DMB content (S54). The broadcasting device records broadcasting using the broadcast recording information (S55).

Thereafter, a memory of the device that records the broadcasting is checked for available capacity (S56). If the memory is limited, the portable terminal queries other devices to ascertain if other devices have sufficient recording capacity (S57) to record the DMB content (S58). The recording of the DMB content is ended in response to a user request or after a predefined recording period (S59).

If the memory of the device that records the broadcasting is limited, a home server may periodically manage a memory status and periodically request other device to record the DMB content. The portable terminal may transmit the broadcast recording information to the home server, and the home server may allow broadcasting devices to directly record the DMB content. Alternatively, the broadcasting device that records the broadcasting may directly request that other devices connected to the home network record the broadcast or request that a PC record the broadcast.

A user may obtain detailed information regarding the broadcast program using an electronic program guide (EPG) with respect to a desired broadcast program, and/or may allow a predetermined device on the home network to record the broadcasting using the broadcast recording information.

A user of the portable terminal may check the position of the stored contents or product information using a code table within the portable terminal. The user may check the device that has recorded the broadcasting through the home server, and then view the broadcast program recorded by the device or any other device.

The portable terminal and broadcasting network allow recording to be continuously performed using an Internet protocol (IP)-based device existing on a network. The broadcast content may be viewed or recorded through the portable terminal and/or any number of devices having unique IP addresses and operatively connected through a home network or other Local Area Network (LAN).

One or more IP-enabled devices may be controlled on the basis of their IP address and connection to the network to record programs or content broadcast through one or more channels, including DMB, to provide a convenient multimedia broadcast service to the user of a portable terminal.

Various modifications, additions and substitutions are possible. Accordingly, other implementations are within the scope of the following claims.

What is claimed is:

1. A method for recording broadcast content comprising:
viewing digitally broadcast content through a portable terminal;
querying one or more devices within a network, wherein the one or more devices are configured to receive and record digitally broadcast content; and
recording the digitally broadcast content using one or more of the queried devices within the network.

2. The method according to claim 1, wherein querying one or more devices comprises determining if the portable terminal is capable of receiving or recording broadcast content.

3. The method according to claim 1, wherein querying one or more devices comprises determining if the portable terminal includes adequate memory or sufficient power to receive or record broadcast content.

4. The method according to claim 1, further comprising informing a user of a recording request if viewing of the digitally broadcast content is limited by available memory or battery power.

5. The method according to claim 1, further comprising determining if available memory of the portable terminal is less than a threshold value.

6. The method according to claim 1, further comprising determining if available battery power of the portable terminal is less than a threshold value.

7. The method according to claim 1, further comprising determining if the portable terminal is within a vicinity of a broadcasting blind zone.

8. The method according to claim 5, wherein querying the one or more devices is in response to determining if available memory is less than the threshold value.

9. The method according to claim 6, wherein querying the one or more devices is in response to determining if available battery power is less than the threshold value.

10. The method according to claim 7, wherein querying the one or more devices is in response to determining if the portable terminal is within the vicinity of a broadcasting blind zone.

11. The method according to claim 1, further comprising recording a program viewed by the portable terminal with one or more of the queried devices.

12. The method according to claim 1, wherein the portable terminal and the one or more queried devices are accessed based on respective IP addresses.

13. The method according to claim 1, wherein querying the one or more devices comprises:
accessing a home server through the portable terminal; and
obtaining information relating to the one or more devices through the accessed home server.

14. The method according to claim 13, wherein the information relating to the one or more devices comprises one or more of a device execution code, IP address information, product information, or storage capacity information.

15. The method according to claim 1, wherein recording the digitally broadcast content comprises:
accessing the one or more queried devices through the terminal; and
transmitting broadcasting recording information to the one or more accessed devices.

16. A method for recording broadcast content comprising:
querying one or more IP-based devices through a portable terminal and a network;
selecting an IP-based device queried through the portable terminal based on available data storage capacity; and
transmitting recording information relating to digitally broadcast content to the selected IP-based device.

17. The method according to claim 16, further comprising recording the digitally broadcast content with the selected IP-based device.

18. The method according to claim 16, further comprising viewing the content through the portable terminal.

19. The method according to claim 18, wherein the recording information relating to digitally broadcast content includes information relating to a broadcast channel currently viewed and information that instructs termination of a recording operation of broadcast content.

20. A method for recording content with a broadcasting device, the method comprising:
requesting a recording request for broadcast content through a portable terminal;
requesting device information relating to recording broadcast content from the portable terminal in response to the recording request; and
receiving broadcast recording information from the portable terminal and recording the broadcast content using the broadcasting recording information with a device other than the portable terminal.

21. The method according to claim 20, further comprising:
querying one or more IP-based devices other than the portable terminal if a data storage capacity, battery power or broadcast reception capability of the portable terminal is less than an optimum value, wherein querying includes accessing information relating to the IP-based devices based on the respective IP addresses;
transmitting the broadcasting recording information to a selected IP-based device having sufficient recording capability; and
recording the broadcast content with the selected IP-based device.

22. A portable terminal comprising:
a receiver part configured to receive and process digitally broadcast content;
a radio part configured to access a wireless network on the basis of an IP (Internet protocol) address; and
a controller configured to control the receiver part and the radio part, wherein the controller is configured to detect one or more limitations on viewing broadcast content through the portable terminal, to inform a user of a recording request, and to query a network or memory within the portable terminal to determine if an alternative IP-based device can record broadcast content received through the receiver part but not capable of being recorded by the portable terminal.

23. The portable terminal according to claim 23, wherein the controller is configured to determine if the portable terminal is capable of receiving or recording broadcast content.

24. The portable terminal according to claim 23, wherein the controller is configured to determine if the portable terminal includes adequate memory or sufficient power to receive or record broadcast content.

25. The portable terminal according to claim 23, wherein the controller is configured to inform a user of the portable terminal of a recording request if viewing of the digitally broadcast content is limited by available memory or battery power.
